(19) United States
(12) Patent Application Publication
(10) Pub. No.: US 2005/0108664 A1
(43) Pub. Date: May 19, 2005

(54) Integrated photonic integrated circuit design, simulation, fabrication, test process and methods therefore

(76) Inventors: Richard S. Johnston, Sammamish, WA (US); George Cagle, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/954,975

(22) Filed: Sep. 29, 2004

Related U.S. Application Data
(60) Provisional application No. 60/507,061, filed on Sep. 29, 2003.

(51) Int. Cl. G06F 17/50

(52) U.S. Cl. 716/1

(57) ABSTRACT

An integrated design, simulation, fabrication, and test environment and process that allows photonic integrated circuits (PICs) to be produced. The process provides for a rapid product development cycle and yields a high probability of the initial device performing as specified.

### RELATED APPLICATION

The present application claims the benefit of priority to U.S. Provisional Patent Application Ser. No. 60/507,061, filed Sep. 29, 2003, and currently co-pending.

### PROBLEM & BACKGROUND

The development of a PIC involves several engineering and manufacturing steps including fabrication process development, device design, simulation, fabrication (itself multiple steps), and test. As in the development of other types of components and systems problems and slowdowns often occur in the handoff between steps. Issues encountered include the following:
Simulation software used to verify the design does not always represent the present fabrication process parameters resulting in devices that do not function as simulated.
The design used to perform simulation must be recreated, often in a different format, to be used by fabrication equipment. This leads to errors in translation resulting in non-functional parts. In addition the translation step leads to additional development time and cost.
The method of verifying the design through simulation and verifying the final part through test are not integrated. This leads to duplication of the testing effort and to devices that fail test after passing simulation.
The lack of a library of design components (subsets of a complete device) results in components being recreated each time they are needed. This is inefficient and increases the likelihood of a design error.

The complexity of PICs only exacerbate these issues. This invention address this problem.

### INVENTION DESCRIPTION

Comp-Optics has addressed this issue through an integrated development environment and an extensive library of proven and tested components. This approach includes the following:
Device design is performed using an integrated CAD and simulation software environment. Fabrication parameters have been incorporated into the environment to assure correlation between the simulation and the produced parts. As these parameters are modified (as may happen during process improvement) the results are automatically incorporated into the simulation process and all library components retested.
Comp-Optics library of components allow designers to select components (couplers, Bragg gratings, switches, etc.) that are needed in the design without having to recreate a component each time it is needed. The library is constantly being added to as new components are developed.
After successful simulation, design files to control the laser writing systems and other equipment used for fabrication are automatically generated and parts created.
The test vectors used for simulation are used to generate the test vectors used to test the fabricated devices.

1. A method for designing a photonic integrated circuit (PIC) comprising the steps of:
determining fabrication parameters for a PIC and incorporating said parameters into the environment;
modification of said parameters;
establishing a library for each said components; and
simulating said PIC to determine performance characteristics.
